(19) United States
(12) Patent Application Publication
(10) Pub. No.: US 2022/0248632 A1
(43) Pub. Date: Aug. 11, 2022

(54) Adaptable Livestock Head Holder with Lower Scoop Extensions and Upper Stabilizer

(71) Applicant: Northquip Inc., Woodlands (CA)

(72) Inventors: Stephen Arthur Langrell, Woodlands (CA); Philip Malcolm Firth, Woodlands (CA)

(21) Appl. No.: 17/627,788

(22) PCT Filed: Oct. 28, 2019
(86) PCT No.: PCT/CA2019/051517

§ 371 Date: Jan. 17, 2022

(51) Int. Cl. A01K 1/062

(52) U.S. Cl. CPC A01K 1/062

(57) ABSTRACT

A livestock head holder with movably supported top and bottom holding members movable by an operating mechanism into a closed state bracing against the topside and underside of an animal's head, neck or jaw region. Selectively attachable scoop extensions for the bottom head holder enable selective enlargement of a neck scoop thereof for more effective performance on larger animals of greater size at said body region. A selectively attachable/removable stabilizer on the top holding member is of increased breadth relative to a main elongated bar of the top holding member to increase the area of surface contact at the topside of said body region. This spreads the holding force over a greater area and reduces pressure concentration on the animal's body to provide increased comfort and a calming effect.

### FIELD OF THE INVENTION

The present invention relates generally to livestock handling equipment, and more particularly to a livestock head holder of a type useful on the head gate of a livestock squeeze chute to provide additional restraint of the animal's head for the purpose of ear-tagging, oral inspection (mouthing), etc.

### BACKGROUND

Applicant has produced and marketed livestock head holders of the aforementioned type, two examples of which are shown in Applicant's granted U.S. Pat. No. 10,039,262, the entirety of which is incorporated herein by reference. In these types of head holders, top and bottom holding members are urged against the top and bottom of the animal's head, neck or jaw region to hold the animal's head in place, for example to restrain the animal's head during ear tagging, oral examination (mouthing), etc. As illustrated by the example shown in FIGS. 1A and 1B of the present application, which was the subject of Applicant's aforementioned U.S. patent, the head holder features a frame 10 mounted to the head gate of a squeeze chute (not shown), and a linkage that includes two holding members 12, 14 connected by an intermediate link 16 and moved via an operating lever 18. The operating lever 18 is connected to the bottom holding member 12 to reach outward therefrom at a first end thereof opposite a U-shaped neck cradle, or neck scoop, 20 that is carried at or adjacent an opposed working end 12b of the bottom holding member 12 to fit against the underside of the animal's neck in a closed state of the head holder. Though the term “neck scoop” is used herein, the particular point of contact of this scoop with the animal's body may vary, for example among the head, neck or jaw region thereof. So, while the term “neck scoop” is used herein in the interest of brevity, it is meant to encompass any scoop-like member arranged to brace upwardly against the animal's body at any such region thereof.

In said closed state, shown in FIG. 1A, both holding members span laterally outward from the frame in a common direction so that the scoop 20 of the bottom holding member resides below the top holding member 14 near a working end 14b thereof in an orientation opening upwardly theretoward. The operating lever 18 is used to transition to the apparatus to this illustrated closed state from an initially opened state, shown in FIG. 1 B, in which the top and bottom holding members instead reach upward and downward from the top and bottom of the frame in nearly vertical orientations. To perform the closing stroke that transitions the linkage from the open state to the closed state, the free end 18a of the operating lever 18 pulled downwardly from its initial position reaching upward from the first end of the upright bottom holding member. This swings the bottom holding member 12 into the laterally reaching orientation of the illustrated closed state to brace the attached neck scoop 20 against the underside of the animal's head, neck or jaw region. During this closing stroke of the head holder, the intermediate link 16 causes the top holding member 14 to simultaneously swing down against the topside of the body region, thereby firmly holding same in a stationary position between the holding members 14, 16 to restrain head movement of the animal.

So that exertion of force against the holding members by attempted movement by the animal will not open the head holder, a lock and release mechanism 22 automatically locks the linkage in the closed state to block movement thereof in a reverse opening stroke that would otherwise allow the holding members to move away from one another toward the opened state. Two different examples of such lock and release mechanism are disclosed in Applicant's aforementioned U.S. patent, each using a different type of input to release the locked state of the linkage, whereupon opening of the apparatus can be completed via completion of an upstroke on the operating lever.

However, prior art head holders leave room for notable improvement, particularly in relation to accommodating animals of different sizes, and in doing so, optimizing the balance between firm holding of the animal in a stationary position, and the comfort of the animal while held in such position.

### SUMMARY OF THE INVENTION

According to a first aspect of the invention, there is provided a livestock head holder comprising:

a movably supported bottom holding member comprising a scoop thereon for engagement with a head, neck or jaw region of an animal's body at an underside thereof;

an operating mechanism operable to effect a closing stroke of the head holder that moves the bottom holding member in a direction lifting the scoop upwardly to brace against the underside of said region in an upward-opening position thereunder in a closed state of the head holder; and

a pair of scoop extensions removably mounted on, or configured for selective mounting to, the scoop on opposite sides thereof in installed positions diverging from one another in a direction moving away from a bottom of the scoop, thereby increasing an effective size of said scoop for use on larger animals of greater body size at said region.

Preferably said pair of scoop extensions are configured to increase said effective span of said scoop in an axial direction thereof when mounted in the installed positions.

Preferably said pair of scoop extensions are configured to increase said effective size of said scoop in a height direction thereof when mounted in the installed positions.

Preferably said pair of scoop extensions are mounted, or configured for mounting, to the scoop at a front end thereof opposite a frame on which the top holding member is movably supported.

Preferably the scoop, at each of said opposite sides thereof comprises a first one of either a female receiver or a male mounting component, and each of said scoop extensions comprises a second cooperating one of either said female receiver or said male mounting component, and wherein each male mounting component is inserted or insertable into a respective one of the female receivers to support the scoop extensions in the installed positions on said scoop.

Preferably the scoop comprises said female receiver at each of said opposing sides thereof, and each scoop extension comprises said male mounting component inserted or insertable into said respective one of the female receivers.

Preferably there are locking components operable to lock the scoop extensions to the scoop in fixed positions thereto when installed thereon.

Preferably, the locking components are engaged or engageable through walls of the female receivers when the male mounting components are received therein to lock scoop extensions at fixed positions relative to the scoop.

Preferably each locking component is a threaded locking component engaged or engageable through a threaded bore on said wall of the female receiver and rotatable in said threaded bore for selective tightening against said male mounting component when received in said female receiver.

Preferably each threaded locking component comprises a wing bolt.

In one embodiment, there is provided a movably supported top holding member that is connected to the operating mechanism such that the closing stroke of the head holder also moves the top holding member downward against the head, neck or jaw region of the animal's body at the topside thereof, wherein said top holding member comprises an elongated bar, and a stabilizer that is carried, or mountable, on said elongated bar at a position thereon that generally aligns with the scoop of the bottom holding member in the closed state of the head holder, said stabilizer being of increased breadth relative to a narrower support portion of said elongated bar by which said stabilizer is movably supported.

Preferably the scoop extensions are configured for selective adjustment of the installed positions thereof.

Preferably the scoop extensions are slidable back and forth in an axial direction to adjust an axial location occupied thereby in the installed positions.

In one embodiment, said pair of scoop extensions are one of a plurality of different sets of scoop extensions, among which the scoop extensions of each set differ from one another in at least one characteristic, whereby selection from among said plurality of different sets enables adjustment of the head holder to better suit different types and/or sizes of animal.

Said pair of scoop extensions may differ from the scoop extensions of at least one other set in relation to an axial measure thereof.

Said pair of scoop extensions may additionally or alternatively differ from the scoop extensions of at least one other set in relation to an angular configuration that determines or contributes to a resulting angle of divergence between the scoop extensions when installed on the scoop.

According to a second aspect of the invention, there is provided a livestock head holder comprising:

a movably supported top holding member for engagement with a head, neck or jaw region of an animal's body at a topside thereof; and

an operating mechanism operable to effect a closing stroke of the head holder that moves the top holding member in a downward direction to brace against the topside of said region in a closed state of the head holder;

wherein said top holding member comprises an elongated bar, and a stabilizer that is carried, or mountable, on said elongated bar at a position thereon that aligns with said region of the animal's body in the closed state of the head holder, said stabilizer being of increased breadth relative to a narrower support portion of said elongated bar by which the stabilizer movably supported.

Preferably said stabilizer is removably mounted, or removably mountable, to said elongated bar of the top holding member.

Preferably said stabilizer is adjustable in position along said elongated bar of the top holding member.

Preferably said stabilizer comprises an opening therein that is sized and shaped to accommodate insertion of the elongated bar of the top holding member therein to selectively mount said stabilizer on said elongated bar.

Preferably said opening communicates fully through said stabilizer from one end thereof to another.

Preferably said stabilizer is configured to close fully around the elongated bar of the top holding member.

Preferably there are one or more locking elements operable to lock the removable stabilizer to the elongated bar of the top holding member at a fixed position thereon.

Preferably said one or more locking elements are engaged or engageable through a wall of the stabilizer when the elongated bar of the top holding member is received therein to lock the stabilizer relative to said bar.

Preferably there are a pair of said locking elements.

Preferably each locking element is a threaded locking element engaged or engageable through a threaded bore on said wall of the stabilizer and rotatable in said threaded bore for selective tightening against said elongated bar of the top holding member when received in said opening.

Preferably each threaded locking element comprises a wing bolt.

### BRIEF DESCRIPTION OF THE DRAWINGS

One embodiment of the invention will now be described in conjunction with the accompanying drawings in which:

FIG. 1A is a front elevational view of a prior art livestock head holder shown in its closed state for bracing an animal's head, neck or jaw region at the topside and underside thereof.

FIG. 1B is a front elevational view of the livestock head holder of FIG. 1A, but in its open state.

FIG. 2 is a front perspective view of a livestock head holder of the present invention, shown in the closed state and featuring a pair of selectively attachable/removable scoop extensions on the bottom holding member, and a selectively attachable/removable stabilizer on the top holding member.

FIG. 3 is a front perspective view of the livestock head holder of FIG. 2 with the scoop extensions removed.

FIG. 4 is a partial closeup view of the livestock head holder of FIG. 3, showing two female receivers on the scoop by which the two scoop extensions are removably mountable thereon.

FIG. 5 is another partial closeup view of the livestock head holder of FIG. 3, but with the two scoop extensions mounted thereon.

FIGS. 6A and 6B are enlarged isolated perspective views of the stabilizer from opposite ends thereof.

FIG. 7 is another perspective view of the head holder of FIG. 2, but viewed from another angle to show how an underside of the stabilizer exceeds the breadth of the top holding member to increase the effective contact area with the topside of an animal's head, neck or jaw region.

FIG. 8A shows the scoop extensions of FIG. 2 in isolation from the head holder, one extension being shown in side elevation and the other being shown in end elevation.

FIG. 8B shows an additional substitutable pair of scoop extensions from the same vantage points as FIG. 8A to illustrate a greater axial length and different angular configuration thereof compared to the scoop extensions of FIG. 8A.

In the drawings like characters of reference indicate corresponding parts in the different figures.

### DETAILED DESCRIPTION

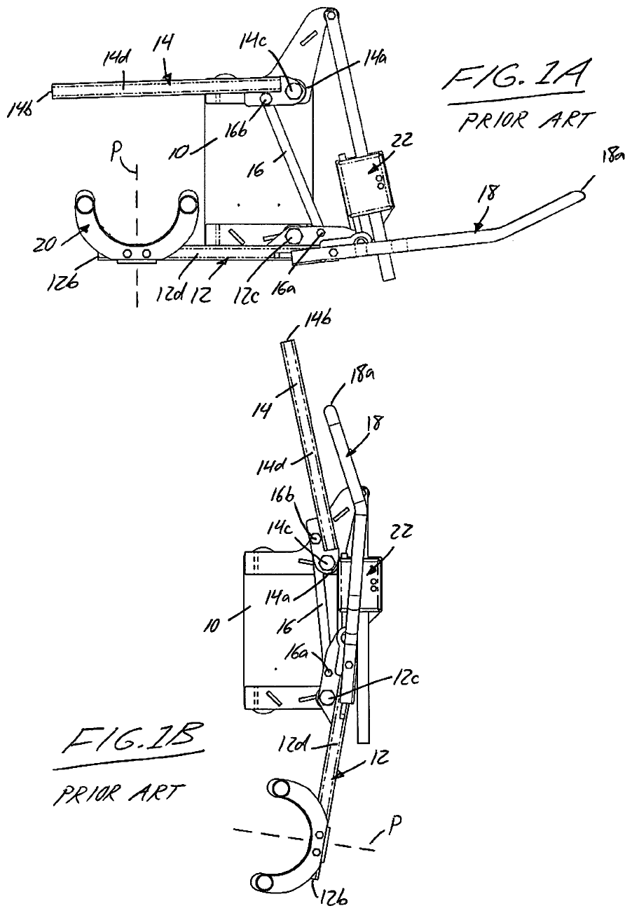

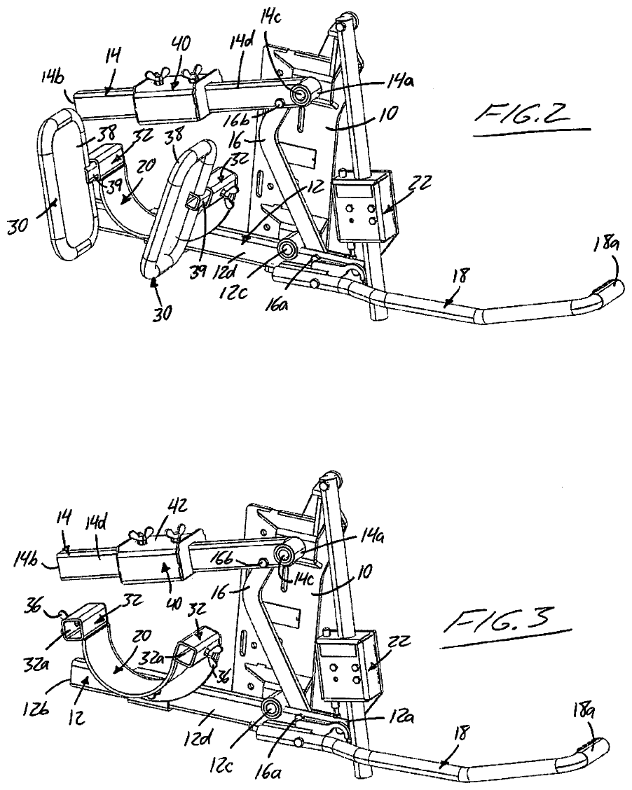

FIG. 2 illustrates a livestock head holder apparatus of the present invention, which features the same frame 10, bottom holding member 12, top holding member 14, intermediate link 16, operating lever 18 and lock and release mechanism 22 as the prior art apparatus of FIGS. 1 A and 1B. The top holding member 14 has a first mounting end 14a and an opposing second working end 14b. Near its first end 14a, the top holding member 14 is pivotally coupled to the frame 10 near an upper end thereof by a respective pivot pin 14c. The bottom holding member 12 also has a first mounting end 12a and an opposing second working end 12b. Near its first end 12a, the bottom holding member 12 is pivotally coupled to the frame 10 near a lower end thereof by a respective pivot pin 12c. The U-shaped neck scoop 20 is attached to the bottom holding member 12 at or near the working end thereof, preferably in a manner adjustable in position therealong to best center the neck scoop in relation to the head gate on which it is installed. Both holding members 12, 14 are pivotally pinned to the frame 10 at a front side thereof by their respective pivot pins, and in the closed state of FIG. 2, both holding members span laterally outward from the frame 10 in a common direction so that the neck scoop 20 of the bottom holding member 12 resides below the top holding member 14 near the working end 14b thereof in an orientation opening upwardly theretoward. Accordingly, in the closed state, the top holding member 14 and the neck cradle 20 of the bottom holding member 12 brace respectively against the topside and underside of the animal's head, neck, or jaw region to restrain and stabilize the animal's head in the same manner as the prior art apparatus.

The intermediate link 16 has its lower end pivotally coupled to the bottom holding member 12 by pivot pin 16a at a location between the bottom holding member's pivot pin 12c and first end 12a. The upper end of the intermediate link 16 is pivotally coupled to the top holding member 14 by pivot pin 16b at a location between the top holding member's pivot pin 14c and working end 14b, but closer to the pivot pin 14c near the first mounting end 14a than to the opposing second working end 14b. Since the intermediate link 16 is thus connected to the top and bottom holding members on opposite sides of their respective pivot pins, it will cause the top holding member 14 to automatically swing in an opposite direction to the bottom holding member 12 when the bottom holding member 12 is swung about its respective pivot pin 12c by the operating lever 18.

Each holding member features an elongated main bar 12d, 14d, for example comprised substantially of a linear length of square metal tubing. Said bar is supported near one of its ends by the respective holding member pivot pin 12c, 14c, and is also pivotally coupled to a respective end of the intermediate link 16 by a respective one of the pivot pins 16a, 16b thereof. The pivot pins 12c, 14c, 16a, 16b coupling the holding members to the frame and coupling the intermediate link to the holding members are all oriented horizontally, and lie parallel to one another in an axial direction perpendicular to the vertical plane of the frame 10, whereby these pins enable movement of the linkage within a vertical working plane parallel and adjacent to the frame 10.

As described in the prior art, the operating lever 18 is connected to the bottom holding member 12 in a manner reaching outwardly beyond the first end 12a thereof, whereby the free end 18a of the lever forms a handle for manual actuation of the linkage movement via the lever 18. Downward movement of the handle from its elevated location in the open state of the head holder (FIG. 1B) is operable to perform a closing stroke that swings the working end 12a, and thus the neck scoop 20, of the bottom holding member 12 upwardly about the pivot point 12c thereof to brace the scoop 20 against the underside of the animal's head, neck or jaw region, while also swinging the working end 14b of the top holding member 14 downward about the pivot point 14c thereof to urge the top holding member downwardly against the topside of the animal's head, neck or jaw region. The lock and release mechanism 22 will normally prevent a reverse opening stroke that would swing the top and bottom holding members respectively upwardly and downwardly to release the animal, until a particular release action is performed by the human operator. In the illustrated design from Applicant's aforementioned granted U.S. patent, the release occurs automatically under initial lifting of the operating lever's handle, whereby performance of the opening stroke can be effected by continued lifting thereof. The lock and release mechanism 22 and operating lever 18 thus cooperably form an overall operating mechanism by which the head holder is manually actuated between its open and closed states.

However, from the following description, it will be appreciated that the inventive scoop extensions and stabilizer of the present invention may be employed on any of a variety of different head holder designs, regardless of the particular design of the linkage in which the holding members are installed, and regardless of the particular type of lock and release mechanism employed to lock the head holder in its closed state. The present invention is therefore not limited to manually operated head holders, and may also be employed in designs where the operating mechanism employs hydraulic actuators or other powered means, rather than a manual operating lever.

The scoop 20 is accompanied by a pair of selectively attachable/removable scoop extensions 30 that can be selectively installed on the scoop to increase the effective size thereof for improved performance on larger animals where the size of the scoop 20 itself may not be sufficient to effectively hold the animal still. In the illustrated embodiment, the scoop extensions 30 are effective to increase the axial span, overall height and overall width of the scoop 20, as described in more detail below.

The axial direction is used herein to refer to the direction in which the pivot axes of the head holder linkage lie, i.e. a direction lying orthogonal to the vertical working plane of the head holder in which the top and bottom holding members pivot. This axial direction also corresponds to a longitudinal direction in which the animal would traverse through a squeeze chute on which the head holder is installed, and the terms front and rear are used herein in relation to this axial direction, whereby the front of the scoop refers to the side thereof furthest from the frame 10 on which the holding members are pivotally supported, and thus furthest outside the head gate of the squeeze chute on which the head holder is installed. The width of the scoop refers to the dimension thereof that, when the head holder is closed, is measured generally horizontally in a transverse direction lying cross-wise to the axial direction of the head holder and corresponding longitudinal dimension of the chute. The height of the scoop refers to the dimension thereof measured generally vertically when the head holder is closed. Expressed alternatively using a reference plane P (FIGS. 1A, 1B) that bisects the U-shaped structure of the scoop 20, the axial span of the scoop is measured horizontally in this reference plane, the height of the scoop is measured orthogonally of the axial span in this same reference plane, and the width of the scoop is measured orthogonally through the reference plane.

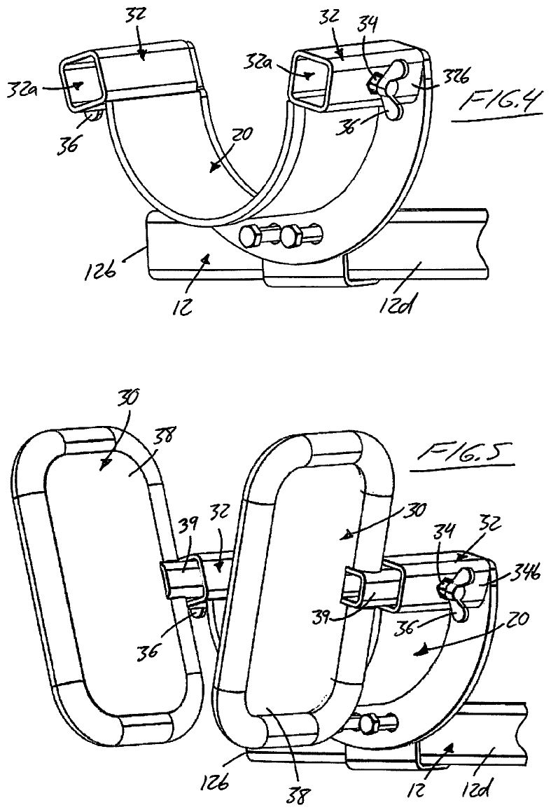

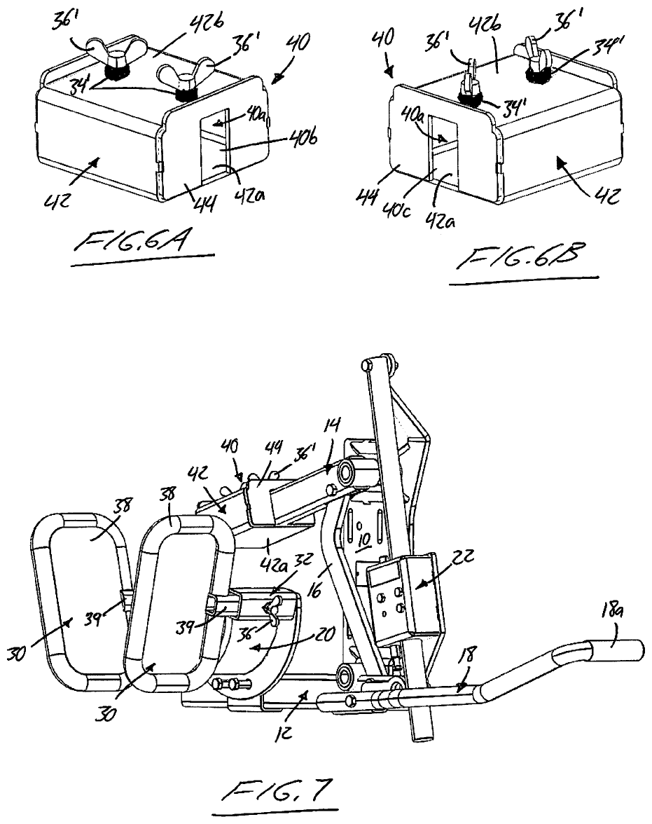

On opposite sides of this bisecting reference plane P, each side of the scoop 20 features a respective female receiver 32 situated at or near a respective terminal end of the scoop furthest from the reference plane P. With reference to FIG. 4, each female receiver 32 features a hollow interior 32a opening axially thereinto from the front side of the scoop 20. Affixed to an exterior wall 32b of each female receiver at an outer side thereof facing outwardly away from both the scoop and its bisecting reference plane P, is at least one threaded nut 34. The nut 34 resides in alignment with a respective aperture that opens through the exterior wall 32 of the female receiver 32 into the hollow interior 32a thereof. The nut 34 thus defines a respective threaded bore opening into the hollow interior 32a of the receiver 32, thus enabling threaded advancement of a respective wing bolt 36 into the hollow interior of the receiver 32 through the threaded bore. Each bolt 36 thus serves as a locking component by which the scoop extension is lockable in place when mated with the respective receiver 32 of the scoop 20.

Each scoop extension 30 in the illustrated embodiment has a paddle-like shape, featuring a relatively broad generally planar main contact body 38 for bracing laterally against a respective side of the animal's head, neck or jaw region, and a comparatively smaller stub shaft 39 projecting axially rearward from the main contact body 38 to serve as a male mounting component axially receivable in the hollow interior 32a of the respective female receiver 32. The main contact body 38 of each scoop extension spans outwardly in two opposing directions from the stub shaft 39, whereby in the extension's installed position on the scoop 20, the main contact body 38 spans both upwardly and downwardly from the stub shaft 39 and the respective female receiver 32 in which the stub shaft 39 is received. While the stub shaft and receiver are of rectangular or square shape in the illustrated embodiment, whereby the straight-sided cross-sectional profiles of the two components prevent relative rotation therebetween when mated together, other rotation-preventing profiles (e.g. splined or faceted profiles) may be employed. Circularly round profiles allowing relative rotation between the components may alternatively be used, thus allowing angular adjustment of the scoop extensions, in which case reliance may be made on the wing bolt 36 or other locking component to prevent such relative rotation when the head holder is in use.

As shown in FIG. 2, typically the scoop extensions are installed in orientations angling upwardly outward, and thus placing their lower ends closer to one another and nearer to the bisecting reference plane, and their upper ends further apart from one another and further outward from the bisecting reference plane. This upwardly divergent relation between the two scoop extensions increases the effective height and width of the scoop, as the top ends of the two scoop extensions are elevated above the two terminal ends of the scoop 20 itself, and are situated further apart from one another than the two terminals ends of the scoop. This way an animal with a wider head, neck or jaw is better accommodated in the extension-augmented scoop, and greater contact area is achieved with the wider animal body part via the augmented scoop height, and also by the augmented axial scoop span contributed by the installed positions of the extensions axially in front of the scoop 20 itself.

While the illustrated embodiment employs female receivers 32 on the scoop and male stub shafts 39 on the scoop extensions, it will be appreciated that the selection of whether to use female receivers on the scoop and corresponding matable male mounting components on the scoop extensions, or vice versa, may be varied within the scope of the present invention. Also, while the illustrated embodiment uses wing bolts 36 to lock the scoop extensions 30 on the scoop 20, it will be appreciated that the particular locking components used may also be varied, and need not be hand-driven winged fasteners, nor even threaded fasteners at all. For example, in another embodiment, a ball detent locking mechanism may be used, where a spring-loaded ball on the male mounting component 39 is biased into engagement with a detent hole in the wall of the female receiver 32.

Scoop extensions of different size and/or configuration may be made available for selective use of different sets of scoop extensions on the head holder to best fit a particular type or size of animal. Such differences in size and configuration are illustrated by comparison of FIGS. 8A and 8B, of which FIG. 8A shows the scoop extensions of the earlier figures in isolation from the rest of the head holder, and FIG. 8B shows a separate substitutable set of different size and configuration from those of FIG. 8A.

Referring to the side elevational views at the left side of FIGS. 8A and 8B, the pair of scoop extensions 30 in FIG. 8A are of lesser size in an axial measure thereof relative to the scoop extensions 30′ of FIG. 8B. More specifically, the stub shafts 39 of the scoop extensions 30 in FIG. 8A protrude a greater axial length L from the main bodies 38 of the scoop extensions than the stub shafts 39′ of the identically-bodied scoop extensions 30′ in FIG. 8B. In both sets, this axial length L exceeds the axial length of the hollow interiors of the female receiver 32 of the neck scoop 20, whereby in a fully inserted position of the stub shaft in one of the female receivers, a distal end 39a of the stub shaft will bottom out against a closed or obstructed rear end of the female receiver 32. In this fully inserted position, the axial length of the stub shaft therefore dictates how far the main body 38 of the scoop extension is situated forwardly of the female receiver 32. The scoop extensions 30′ of FIG. 8B thus have a greater overall axial measure than the scoop extensions 30 of FIG. 8A, and will place their main bodies 38 further forwardly of the neck scoop to contact a more forwardly-situated body region of the animal than the scoop extensions 30 of FIG. 8A. It will be appreciated that the overall axial measure of the scoop extensions may additionally or alternatively be varied by differences in the axially measured width of the main bodies 38 thereof, which would also affect the overall axial span of the extended neck scoop and the achieved area of contact with the animal's body.

Referring to the elevational end views on the right side of FIGS. 8A and 8B, the set of scoop extensions 30′ in FIG. 8B also differ from the set shown in FIG. 8A in terms of the angular relationship of the main bodies 38 of the scoop extensions relative to the stub shafts 39 thereof about the central longitudinal axes A of the stub shafts. The scoop extensions 30′ in FIG. 8B have a greater degree of angular tilt of the main body 38 about the axis A of the stub shaft 39, whereby the two extensions 30′ of FIG. 8B, when installed on the head holder, are oriented at a greater angle of upward divergence from one another than the scoop extensions 30 of FIG. 2. Accordingly, by choosing between two or more sets of scoop extensions of varying angular configuration, the user can select the best angular fit for the type and size of animal concerned, just as by choosing between two or more sets of scoop extensions of varying axial measure, the user can select the best axial span and achieved contact area of the extended neck scoop to best fit the type and size of animal concerned.

In addition to adjustability of the axial span and body contact area of the extended neck scoop by substituting one set of extensions for a differently sized set, the axial span of the extended scoop can be adjusted without swapping extensions by loosening of the locking components 36 and sliding of the stub shaft 39 into, and re-locking of the stub shaft in, a partially withdrawn position that increases the forward axial reach of the extension 30 from the receiver, thus increasing the overall axial span and forward reach of the extended scoop without substituting an axially larger set of extensions. The illustrated embodiments thus enable adjustment of the installed position each extension to different axial locations to change the forward reach and resulting area of body contact of the extended scoop without necessarily having to include multiple sets of differently sized extensions.

Turning attention away from the bottom holding member 12 and the extendable scoop 20 thereof, the top holding member 14 features a selectively attachable/removable stabilizer 40 mounted on the main elongated bar 14d thereof near the working end 14b thereof at a position that generally aligns over the scoop 20 of the lower holding member 12 in the closed state of the head holder. The stabilizer 40 is a generally block-shaped unit whose breadth in the axial direction exceeds that of the elongated bar 14d on which it is mounted. The stabilizer 40 has a receiving space 40a into which the working end 14b of the rectangular bar 14d is receivable by a rectangular opening 40b at a first proximal end of the stabilizer 40 that resides nearest the first end 14a of the top holding member 14 when mounted thereon. In the illustrated example, the stabilizer also has a matching rectangular opening 40c in an opposing second distal end of the stabilizer, whereby the elongated bar 14d of the top holding member 14 is passable through the entire stabilizer 40 from one end thereof to the other. This way, not only is the stabilizer receivable onto the elongated bar 14d at the working end 14b thereof, but is also slidable back and forth along the elongated bar 14d to adjust the position of the stabilizer 40 thereon to achieve the optimal placement according to the type and size of animal concerned.

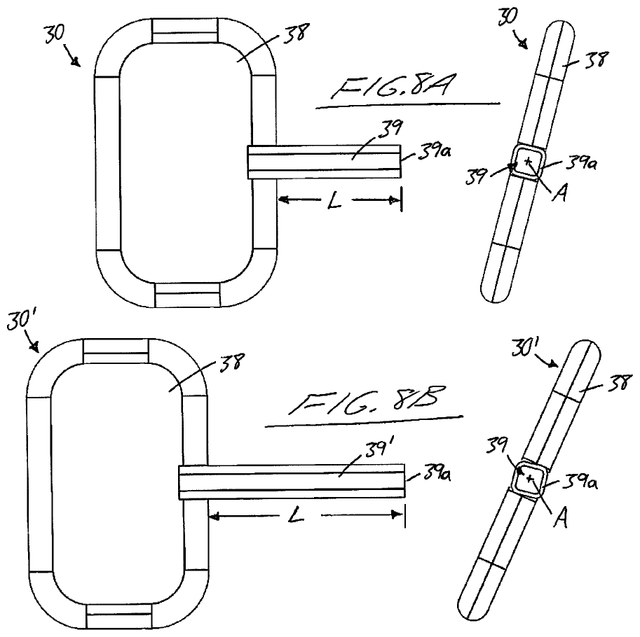

In the illustrated example, the stabilizer 40 is a hollow block having an outer shell 42 that spans around the elongated bar 14d on all four sides thereof, and two end plates 44 that close off the ends of the shell and have the rectangular openings 40b, 40c therein through which the elongated bar 14d is passed through said hollow interior. A bottom wall 42a of the shell 42, visible in FIG. 7, thus spans under the elongated bar 14d and defines the lowermost contact surface of the stabilizer 40 that abuts against the topside of the animal's head, neck or jaw region in the closed state of the head holder. Since the breadth of this contact surface 42a exceeds the breadth of the elongated bar 14d in the axial direction of the head holder, this means that the downforce applied by the top holding member 14 to the topside of the animal's head, neck or jaw region is spread out over a greater area than if direct contact occurred between the bottom of the elongated bar 14d and the animal's body. Thus, a greater holding force can be employed to better hold the animal still, without creating higher pressure points that might cause excess discomfort to the animal. It has also been found that this increased contact area at the topside of the contacted animal part has a tendency to help calm the animal relative to the smaller contact area of the prior art.

However, should the localized enlargement of the top holding member's contact area by the stabilizer 40 be unsuitable for use with calves or other smaller animals, the attachable/removable design of the illustrated embodiment allows the stabilizer 40 to be selectively removed. In the illustrated embodiment, the locking mechanism by which the removable stabilizer 40 is secured to the elongated bar 14d of the top holding member is similar to those described for the locking of the scoop extensions 30 to the bottom holding member 12. Accordingly, a pair of nuts 34′ are externally affixed to top shell wall 42b of the stabilizer 40, and each nut 34′ resides in alignment with a respective aperture that opens through this top wall 42b of the stabilizer 40 into the receiving space thereof. Each such nut 34′ thus defines a threaded bore opening into the receiving space of the stabilizer 40 in order to enable threaded advancement of a respective wing bolt 36′ downwardly into the receiving space of the stabilizer 40 to serve as a locking element by which the stabilizer 40 is lockable to the elongated bar 14d at a selected, slidably adjustable position therealong. Like with the locking components 36 for the scoop extensions, one locking element 36′ may be sufficient, though the illustrated use of two wing bolts or other locking elements may be preferable. Once again, locking mechanisms other than wing bolts or other threaded fasteners may be employed, for example including a ball detent locking mechanism comprising a spring-loaded ball on the topside of the elongated bar 14d to cooperate with at least one detent in the top wall 42b of the stabilizer 40, of which there may be multiple detents to still allow slidable adjustment of the stabilizer to various positions along the elongated bar 14d.

While the illustrated stabilizer 40 closes around the elongated bar 14d on all four sides thereof, and uses tightenable locking elements 36′ at the top 42b of the stabilizer to clamp the stabilizer on the elongated bar 14d by drawing the bottom wall 42a of the stabilizer upwardly against the underside of the elongated bar 14d, this need not necessarily be the case provided that sufficient securement means of some type is included to prevent loosening and falling of the stabilizer from the bar 14d. The illustrated example features a hollow shell 42 whose hollow interior defines a larger receiving space of non-conforming shape and size to the elongated bar 14d, and therefore instead relies on the rectangular openings 40b, 40c in the end walls 40 to generally conform with the size and shape of the rectangular elongated bar to prevent relative rotation between the stabilizer 40 and bar 14d, and to thereby constrain movement between same to sliding motion when the locking elements 36′ are loosened. However, in another alternative embodiment, the stabilizer may comprise a solid block of material with a rectangular slot or channel molded or machined into the top or bottom thereof to accommodate insertable/slidable receipt of the elongated arm, with the open side of the channel then optionally being capped off with a cover plate affixed to the solid block. In one possible implementation where a channeled block embraces over the topside of the elongated bar without an attached cover plate covering the open side of the channel beneath the elongated bar, the overall contact area for abutting the topside of the animal's head, neck or jaw region may optionally be cooperatively defined by the underside of the elongated bar and neighbouring flush bottom surfaces of the stabilizer block situated axially in front of and behind the elongated bar.

Though the design of the stabilizer 40 as a removable attachment enables optional removal if the increased contact area isn't compatible with the body size and shape of calves or other smaller animals, in other embodiments the stabilizer may be an integral or permanently attached enlargement on the elongated bar of the top holding member, for example being part of an integrally cast metal bar or integrally molded plastic bar of sufficient rigidity, or in another example being permanently welded to the rectangular tubing or other initially separate bar component. Whether removable or permanent, the stabilizer provides localized enlargement whose axial breadth exceeds that of a narrower neighbouring support portion of the bar that spans between the pivot point 14c of the top holding member and this localized enlargement to movably carry the stabilizer about this pivot point.

Since various modifications can be made in my invention as herein above described, and many apparently widely different embodiments of same made within the scope of the claims without departure from such scope, it is intended that all matter contained in the accompanying specification shall be interpreted as illustrative only and not in a limiting sense.

1. A livestock head holder comprising:
a movably supported bottom holding member comprising a scoop thereon for engagement with a head, neck or jaw region of an animal's body at an underside thereof;
an operating mechanism operable to effect a closing stroke of the head holder that moves the bottom holding member in a direction lifting the scoop upwardly to brace against the underside of said region in an upward-opening position thereunder in a closed state of the head holder; and
a pair of scoop extensions removably mounted on, or configured for selective mounting to, the scoop on opposite sides thereof in installed positions diverging from one another in a direction moving away from a bottom of the scoop, thereby increasing an effective size of said scoop for use on larger animals of greater body size at said region.

2. The livestock head holder of claim 1 wherein said pair of scoop extensions are configured to increase said effective span of said scoop in an axial direction thereof when mounted in the installed positions.

3. The livestock head holder of claim 1 wherein said pair of scoop extensions are configured to increase said effective size of said scoop in a height direction thereof when mounted in the installed positions.

4. The livestock head holder of claim 1 wherein said pair of scoop extensions are mounted, or configured for mounting, to the scoop at a front end thereof opposite a frame on which the top holding member is movably supported.

5. The livestock head holder of claim 1 wherein the scoop, at each of said opposite sides thereof comprises a first one of either a female receiver or a male mounting component, and each of said scoop extensions comprises a second cooperating one of either said female receiver or said male mounting component, and wherein each male mounting component is inserted or insertable into a respective one of the female receivers to support the scoop extensions in the installed positions on said scoop.

6. The livestock head holder of claim 5 wherein the scoop comprises said female receiver at each of said opposing sides thereof, and each scoop extension comprises said male mounting component inserted or insertable into said respective one of the female receivers.

7. The livestock head holder of claim 1 further comprising locking components operable to lock the scoop extensions to the scoop in fixed positions thereto when installed thereon.

8. The livestock head holder of claim 5 wherein for each of the scoop extensions, there is provided at least one respective locking component engaged or engageable through a wall of the female receiver when the male mounting component is received therein to lock scoop extension at a fixed position relative to the scoop.

9. The livestock head holder of claim 8 comprising a respective pair of said locking components for each scoop extension.

10. The livestock head holder of claim 8 wherein each locking component is a threaded locking component engaged or engageable through a threaded bore on said wall of the female receiver and rotatable in said threaded bore for selective tightening against said male mounting component when received in said female receiver.

11. The livestock head holder of claim 10 wherein each threaded locking component comprises a wing bolt.

12. The livestock head holder of claim 1 further comprising a movably supported top holding member, and is connected to the operating mechanism such that the closing stroke of the head holder also moves the top holding member downward against the head, neck or jaw region of the animal's body at the topside thereof, wherein said top holding member comprises an elongated bar, and a stabilizer that is carried, or mountable, on said elongated bar at a position thereon that generally aligns with the scoop of the bottom holding member in the closed state of the head holder, said stabilizer being of increased breadth relative to a narrower support portion of said elongated bar by which said stabilizer is movably supported.

13. The livestock head holder of claim 12 wherein said stabilizer is removably mounted, or removably mountable, to said elongated bar of the top holding member.

14. The livestock head holder of claim 12 wherein said stabilizer is adjustable in position along said elongated bar of the top holding member.

15. The livestock head holder of claim 13 wherein said stabilizer comprises an opening therein that is sized and shaped to accommodate insertion of the elongated bar of the top holding member therein to selectively mount said stabilizer on said elongated bar.

16. The livestock head holder of claim 15 wherein said opening communicates fully through said stabilizer from one end thereof to another.

17. The livestock head holder of claim 15 wherein said stabilizer is configured to close fully around the elongated bar of the top holding member.

18. The livestock head holder of claim 13 further comprising locking elements operable to lock the removable stabilizer to the elongated bar of the top holding member at a fixed position thereon.

19. The livestock head holder of claim 15 comprising at least one locking element engaged or engageable through a wall of the stabilizer when the elongated bar of the top holding member is received therein to lock the stabilizer relative to said bar.

20. The livestock head holder of claim 19 comprising a pair of said locking elements.

21. The livestock head holder of claim 19 wherein each locking element is a threaded locking element engaged or engageable through a threaded bore on said wall of the stabilizer and rotatable in said threaded bore for selective tightening against said elongated bar of the top holding member when received in said opening.

22. The livestock head holder of claim 21 wherein each threaded locking element comprises a wing bolt.

23. The livestock head holder of claim 1 wherein the scoop extensions are configured for selective adjustment of the installed positions thereof.

24. The livestock head holder of claim 23 wherein the scoop extensions are slidable back and forth in an axial direction to adjust an axial location occupied thereby in the installed positions.

25. The livestock head holder of claim 1 wherein said pair of scoop extensions are one of a plurality of different sets of scoop extensions, among which the scoop extensions of each set differ from one another in at least one characteristic, whereby selection from among said plurality of different sets enables adjustment of the head holder to better suit different types and/or sizes of animal.

26. The livestock head holder of claim 23 wherein said pair of scoop extensions differ from the scoop extensions of at least one other set in relation to an axial measure thereof.

27. The livestock head holder of claim 25 wherein said pair of scoop extensions differ from the scoop extensions of at least one other set in relation to an angular configuration that determines or contributes to a resulting angle of divergence between the scoop extensions when installed on the scoop.

28. A livestock head holder comprising:
a movably supported top holding member for engagement with a head, neck or jaw region of an animal's body at a topside thereof; and
an operating mechanism operable to effect a closing stroke of the head holder that moves the top holding member in a downward direction to brace against the topside of said region in a closed state of the head holder;
wherein said top holding member comprises an elongated bar, and a stabilizer that is carried, or mountable, on said elongated bar at a position thereon that aligns with said region of the animal's body in the closed state of the head holder, said stabilizer being of increased breadth relative to a narrower support portion of said elongated bar by which the stabilizer movably supported.

29. The livestock head holder of claim 28 wherein said stabilizer is removably mounted, or removably mountable, to said elongated bar of the top holding member.

30. The livestock head holder of claim 28 wherein said stabilizer is adjustable in position along said elongated bar of the top holding member.

31. The livestock head holder of claim 29 wherein said stabilizer comprises an opening therein that is sized and shaped to accommodate insertion of the elongated bar of the top holding member therein to selectively mount said stabilizer on said elongated bar.

32. The livestock head holder of claim 31 wherein said opening communicates fully through said stabilizer from one end thereof to another.

33. The livestock head holder of claim 31 wherein said stabilizer is configured close fully around the elongated bar of the top holding member.

34. The livestock head holder of claim 29 further comprising locking elements operable to lock the removable stabilizer to the elongated bar of the top holding member at a fixed position thereon.

35. The livestock head holder of claim 31 comprising at least one locking element engaged or engageable through a wall of the stabilizer when the elongated bar of the top holding member is received therein to lock the stabilizer relative to said bar.

36. The livestock head holder of claim 35 comprising a pair of said locking elements.

37. The livestock head holder of claim 35 wherein each locking element is a threaded locking element engaged or engageable through a threaded bore on said wall of the stabilizer and rotatable in said threaded bore for selective tightening against said elongated bar of the top holding member when received in said opening.

38. The livestock head holder of claim 37 wherein each threaded locking element comprises a wing bolt.
